(19) United States
(12) Patent Application Publication
(10) Pub. No.: US 2010/0321373 A1
(43) Pub. Date: Dec. 23, 2010

(54) IMAGE DISPLAY APPARATUS AND METHOD FOR CONTROLLING THE SAME

(75) Inventors: Yasuhiko Sano, Sagamihara-shi (JP); Kenji Shino, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/815,097

(22) Filed: Jun. 14, 2010

(30) Foreign Application Priority Data
Jun. 18, 2009 (JP) 2009-145455

(51) Int. Cl. G09G 5/00

(52) U.S. Cl. 345/212

(57) ABSTRACT

In a method for controlling an image display apparatus provided with a display panel including electron emitting devices connected to scan wirings and modulation wirings and light emitting members for emitting light by irradiation with electrons, a modulation voltage pulse is generated such that its pulse width becomes longer than that of a scan voltage pulse, and the modulation voltage pulse is started to be output before start of output of the scan voltage pulse whereas it is ended after end of the output of the scan voltage pulse.

### BACKGROUND OF THE INVENTION

1. Field of the Invention

The present invention relates to an image display apparatus provided with a display panel including display devices arranged in a matrix such as a field emission display, and a method for controlling the image display apparatus.

2. Description of the Related Art

There has been known a flat type image display apparatus such as a display apparatus using electron emitting devices (i.e., an electron beam display apparatus). The image display apparatus of this type includes a display panel (i.e., a matrix panel) having a plurality of display devices arranged in a matrix and a drive circuit for driving the display devices. Such a display panel is provided with a plurality of scan wirings and a plurality of modulation wirings having insulating layers held between the plurality of scan wirings and the same and crossing the plurality of scan wirings, so as to independently drive the plurality of display devices. The display devices corresponding to one line (or a plurality of lines) commonly connected to one scan wiring (or a plurality of scan wirings) are allowed to emit light (be driven) at the same time, and then, the light emission of one line (or a plurality of lines) is sequentially switched, thereby displaying one screen. More particularly, a scan wiring connected to a display device which is allowed to emit light (or to be driven or to be displayed) is selected, and then, a selection potential (i.e., a scan voltage pulse) is supplied to the selected scan wiring. At the same time, a modulation signal modulated in response to an input video signal (i.e., a modulation voltage pulse) is supplied to a modulation wiring connected to the display device which is allowed to emit light. This operation is sequentially performed while switching a scan wiring to be selected. A voltage defined by a difference between a peak value of the scan voltage pulse (a scan potential) and a peak value of the modulation voltage pulse (a modulation potential) is applied to the display device connected to the selected scan wiring. Only a display device whose voltage reaches a voltage (i.e., a drive voltage) required for light emission (driving) of the display device is allowed to emit light (to be driven). Light emission amount from the display device to be driven is adjusted by modulating the width of the modulation voltage pulse (a modulation signal) (i.e., pulse width modulation) and/or modulating the peak value (i.e., amplitude modulation).

Japanese Patent Application Laid-open No. 11-176363 discloses drive unit which limits a current at the time of falling of a modulation signal.

Moreover, Japanese Patent Application Laid-open No. 2007-108365 discloses that a pulse width of a modulation voltage pulse is made greater than that of a scan voltage pulse.

### SUMMARY OF THE INVENTION

Accompanied with higher precis ion of a display panel or a higher driving speed of a display device, it is desirable that occurrence of disturbance of a waveform of an applied voltage should be suppressed to achieve stable driving of the display device when a voltage to be applied to the display device is transited. In particular, in an image display apparatus such as an electron beam display apparatus, a capacitance between a scan wiring and a modulation wiring or a capacitance of a display device is great, and further, a driving voltage also is large. Therefore, disturbance of a pulse waveform accidentally occurs due to a transient current flowing in a modulation wiring and/or a scan wiring caused by a high frequency component included in a pulse waveform of a scan voltage pulse or a modulation voltage pulse.

In other words, a disturbance of a waveform (i.e., a crosstalk) dV of a scan potential to be applied to a scan wiring occurs via a wiring capacitance or a device capacitance of a matrix panel at the time of rising and falling of a modulation voltage pulse to be applied to a modulation wiring, as illustrated in FIG. 3. Consequently, a voltage to be applied to a display device which is allowed to emit light is shifted from a desired value, to deteriorate gradation controllability, thereby raising an issue of an adverse influence on a quality of an image to be displayed.

In view of this, it is desired that the disturbance of the waveform of the scan voltage pulse to be applied to the scan wiring should be suppressed at the time of rising and falling of a modulation voltage pulse.

This invention is to solve the problem and the construction is that,

an image display apparatus comprising:

a display panel including a plurality of light emitting members for emitting light by irradiation with electrons emitted from a plurality of electron emitting devices arranged in a matrix with a plurality of scan wirings and a plurality of modulation wirings,

a scanning unit which outputs a selection potential to a scan wiring selected from the plurality of scan wirings and outputs a non-selection potential to non-selected scan wirings,

a modulation unit which generates a modulation voltage pulse based on image data and outputs the modulation voltage pulse to the modulation wirings, and

a control unit which generates a control signal to control the scanning unit and the modulation unit,

wherein

a set of the electron emitting devices for emitting electrons is switched in a line-sequential manner by switching of the scan wiring being supplied with the selection potential,

the control unit controls the scanning unit and the modulation unit such that a potential output to the scan wiring selected from the plurality of scan wirings from the scanning unit is transited from the non-selection potential to the selection potential, at a timing after a lapse of a predetermined period of time after a potential of the modulation voltage pulse to be output to the modulation wiring from the modulation unit is transited to a potential based on the image data, and

the control unit controls the scanning unit and the modulation unit such that the potential of the modulation voltage pulse to be output to the modulation wiring from the modulation unit is transited to a potential Vp having a difference from the non-selection potential, the difference being equal to or lower than a threshold voltage required for light emission in the electron emitting device, at a timing after a lapse of a predetermined period of time after the potential to be output from the scanning unit to the selected scan wiring is transited from the selection potential to the non-selection potential.

According to the present invention, at the time of start of driving of an electron emitting device connected to a predetermined scan wiring, a scan voltage pulse is started to be output to the scan wiring (i.e., a selected scan wiring) connected to the predetermined electron emitting device after a lapse of a predetermined time from the start of an output of a modulation voltage pulse to a modulation wiring. In contrast, at the time of completion of the driving, a timing is controlled such that the output of the modulation voltage pulse is completed after a lapse of a predetermined time from the completion of the output of the scan voltage pulse to the scan wiring.

In this manner, the disturbance of the waveform caused by the transient current flowing in the scan wiring and the modulation wiring can occur during a period of time other than an image display period (i.e., other than a period when both of a scan voltage pulse and a modulation voltage pulse are applied to a display device to be driven). Thus, it is possible to remarkably enhance the gradation controllability of the image display apparatus.

Further features of the present invention will become apparent from the following description of exemplary embodiments with reference to the attached drawings.

### BRIEF DESCRIPTION OF THE DRAWINGS

FIGS. 1A and 1B are timing charts illustrating control timings and drive waveforms;

FIGS. 2A to 2C are block diagrams illustrating the configurations of a modulation circuit and a scanning circuit in an image display apparatus;

FIG. 3 is a timing chart illustrating a drive waveform in the prior art;

FIGS. 4A to 4C are graphs illustrating a luminance waveform with respect to the drive waveform; and

FIGS. 5A and 5B are views schematically illustrating a display panel.

### DESCRIPTION OF THE EMBODIMENTS

An image display apparatus includes a display panel (i.e., a matrix panel) having a plurality of display devices, a plurality of scan wirings, and a plurality of modulation wirings, each of the display devices being connected to one of the scan wirings and one of the modulation wirings. In particular, in an electron beam display apparatus, a wiring capacitance or a device capacitance of the display panel is large, and further, a drive voltage to be supplied to the device also is large. Therefore, the present invention is preferably applied to the electron beam display apparatus. A field emission type electron emitting device such as a spinto type electron emitting device, a MIM type electron emitting device, and a surface conduction type electron emitting device can be used as an electron emitting device constituting a display device in the electron beam display apparatus. The electron beam display apparatus using the field emission type electron emitting device is generally called a field emission display. The display device in the electron beam display apparatus includes electron emitting devices and light emitting members such as phosphors which emit light by irradiation with electrons emitted from the electron emitting devices. Hence, it is the electron emitting device constituting the display device that is connected to a scan wiring and a modulation wiring in the electron beam display apparatus.

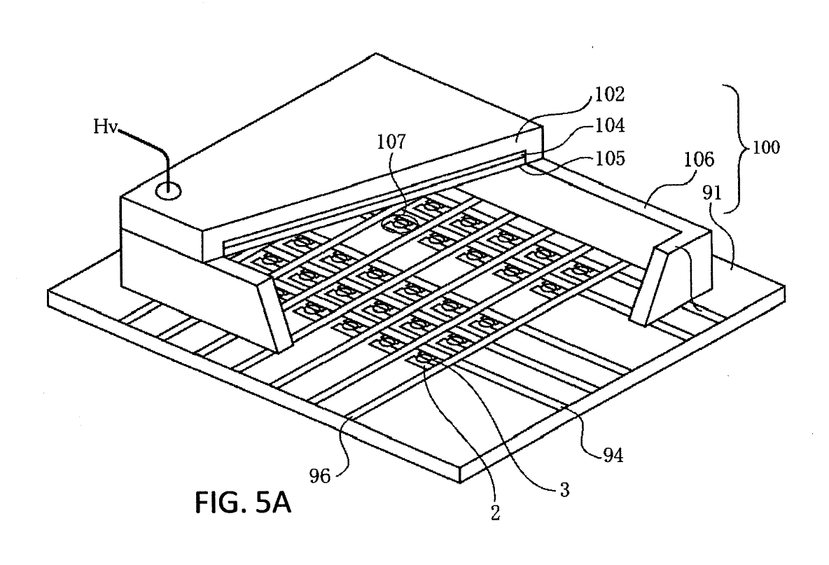

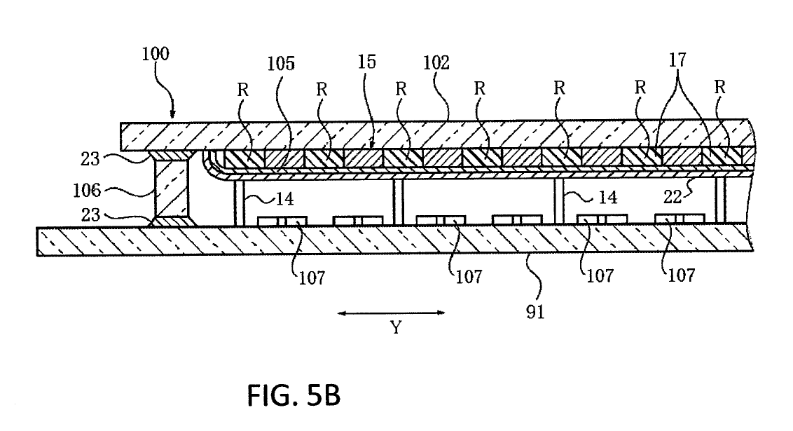

FIG. 5A is a perspective view schematically illustrating one example of a display panel 100 in an electron beam display apparatus. In addition, FIG. 5B is a cross-sectional view schematically illustrating a part of the display panel illustrated in FIG. 5A. Here, FIG. 5A is partly cut away for the sake of understanding of the inside of the display panel 100.

In this display panel 100, a support frame 106 is held between a back board 91 and a front board 102. Joint members 23 made of frit glass seal spaces defined between the support frame and the back board and between the support frame and the front board 102. A spacer 14 may be interposed between the front board 102 and the back board 91, as illustrated in FIG. 5B. Display devices are arranged in a matrix. An electron emitting device 107 constituting each of the display devices is connected to one of a plurality of scan wirings 96 and one of a plurality of modulation wirings 94. The front board 102 includes a transparent board 103 made of glass or the like, light emitting members 104 disposed on the side of the back board 91, and an anode electrode 105. In particular, each of the light emitting members 104 is disposed in such a manner as to face each of the electron emitting devices 107, and further, includes a phosphor 17 for emitting light of any one of red (R), green (G), and blue (B) colors, as illustrated in FIG. 5B. A black member 15 is held between the phosphors 17. The anode electrode 105 is normally made of an aluminum thin film called metal back. A getter layer 22 may be disposed on the metal back on the side of the back board 91, as illustrated in FIG. 5B. A potential as high as about 10 kV is applied to the anode electrode 105 through an anode terminal Hv. An electron emitted from the electron emitting device 107 is introduced by the potential of the anode electrode, to pass the metal back, and then, collides with the phosphor, thus allowing each of the display devices (i.e., the light emitting devices) to emit light.

The display panel is actuated by a line sequential system. In the line sequential system, a scan voltage pulse is output to one selected from N scan wirings 96, and further, a modulation voltage pulse modulated in response to a video signal (i.e., image data) is output to M modulation wirings 94 in synchronism with the output of the scan voltage pulse. In this manner, an electron is emitted from each of the plurality of electron emitting devices connected to the selected scan wiring (i.e., the electron emitting devices corresponding to one line), so that the phosphors 17 corresponding to one line according to each of the electron emitting devices emit the light. One screen is displayed by sequentially switching the selected scan wiring (i.e., the scan wiring from which the scan voltage pulse is output).

Although the number of scan wirings to be selected at the same time is set to one (i.e., one line) herein for the sake of simple description, the number of scan wirings to be selected at the same time may be plural. That is to say, a system for driving the display panel in the present embodiment is designed to display one screen by sequentially switching one or more lines to be allowed to emit the light (i.e., to emit the electron). Therefore, this system is different from a drive system for allowing all of lines to emit the light at the same time (e.g., hold drive).

The above-described image display apparatus includes a scanning circuit and a modulation circuit as drive unit which drives the display panel. The scanning circuit is configured to output a scan voltage pulse having a selection potential to one or more scan wirings to be driven. In contrast, the modulation circuit is configured to produce a modulation voltage pulse based on image data, to output the modulation voltage pulse to modulation wirings. A control circuit in the image display apparatus is configured to control the scanning circuit and the modulation circuit. Specifically, the control circuit controls the scanning circuit and the modulation circuit at the beginning of the output of the scan voltage pulse in such a manner as to start the output of the modulation voltage pulse to the modulation wirings before the start of the output of the scan voltage pulse to the scan wiring. In contrast, the control circuit controls the scanning circuit and the modulation circuit at the end of the output of the scan voltage pulse in such a manner as to end the output of the scan voltage pulse to the scan wiring before the end of the output of the modulation voltage pulse to the modulation wirings.

### First Embodiment

Next, a description will be given below of the configuration of the above-described image display apparatus for outputting a scan voltage pulse and a modulation voltage pulse and a control method therefor in a first embodiment.

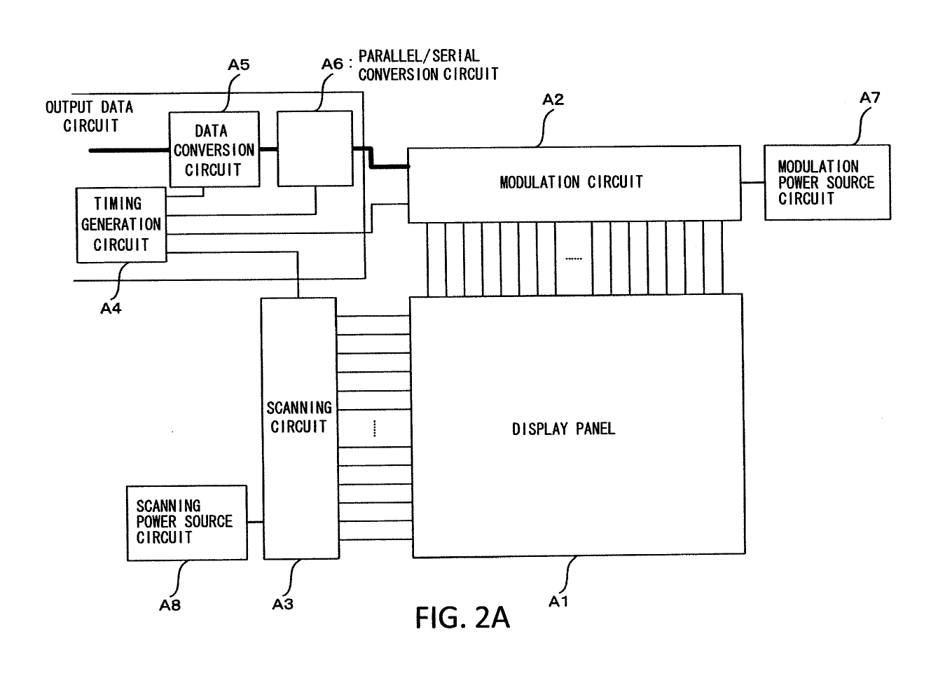

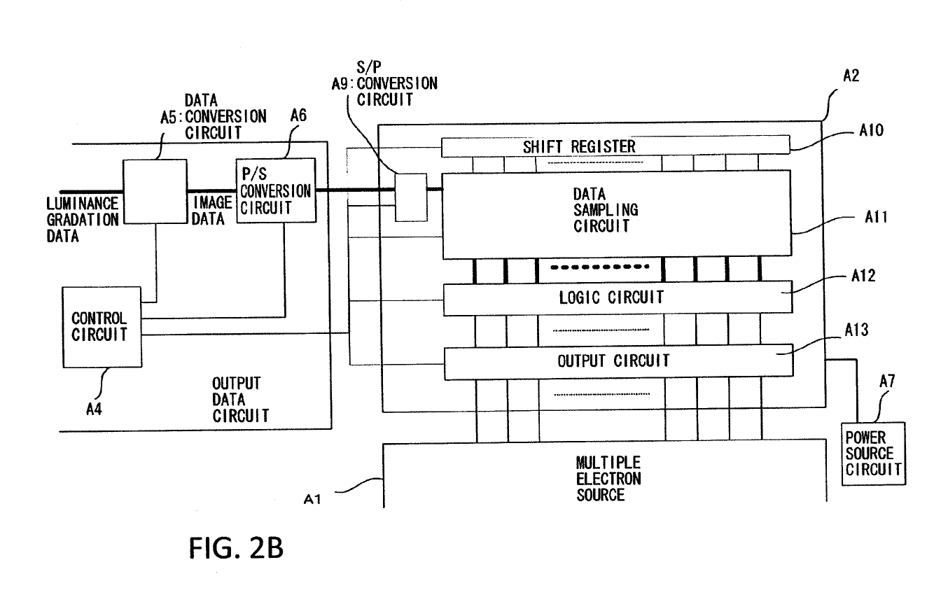

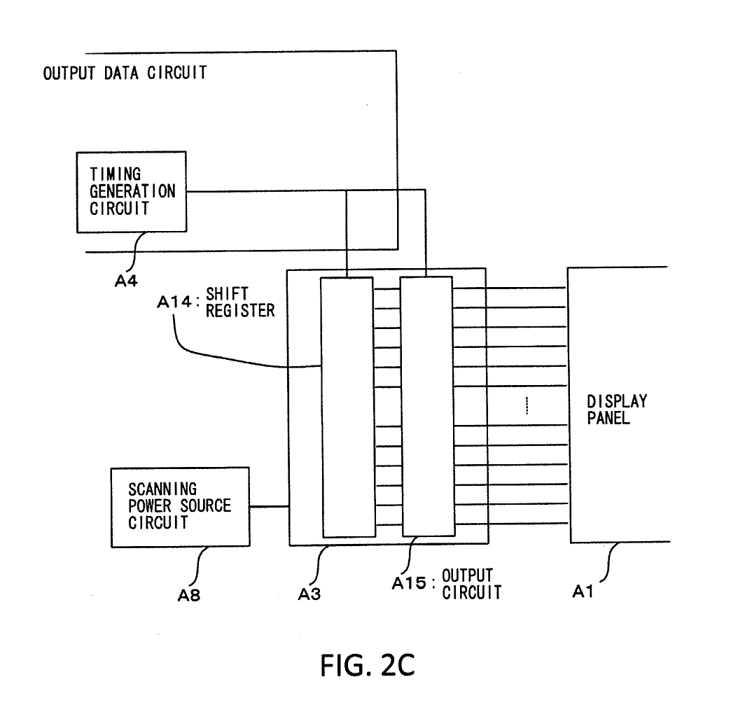

FIG. 2A illustrates the configuration of the image display apparatus. The image display apparatus includes a display panel A1 serving as an image display unit, a modulation circuit A2, a scanning circuit A3, a control circuit A4, a data conversion circuit A5, a parallel/serial conversion circuit A6, a modulation power source circuit A7, and a scanning power source circuit A8.

The display panel A1 corresponds to the display panel 100 illustrated in FIGS. 5A and 5B, and includes a plurality of electron emitting devices 107, a plurality of scan wirings 96, and a plurality of modulation wirings 94. The electron emitting device is located at a cross portion of the scan wiring 96 and the modulation wiring 94 or in the vicinity thereof.

When a scan voltage pulse having a selection potential is supplied to a selected scan wiring whereas a modulation voltage pulse is supplied to a modulation wiring, a voltage, which is a difference in potential between the scan voltage pulse and the modulation voltage pulse, is applied to the electron emitting device. A predetermined display device can be allowed to emit light at a predetermined luminance by appropriately controlling the application time or the value of the voltage.

The modulation circuit A2 is connected to the modulation wirings in the display panel A1. The modulation circuit A2 produces a modulation signal (i.e., the modulation voltage pulse) based on image data supplied from an output data circuit, thereby outputting the modulation signal to each of the modulation wirings in the display panel A1.

The modulation power source circuit A7 is configured in such a manner as to freely output a plurality of voltage values (i.e., potentials). In other words, the modulation voltage pulse can be modulated in amplitude. The modulation power source circuit A7 serves as a power source for actuating the modulation circuit A2, and further, as a power source for defining a peak value (i.e., a voltage value) of the modulation voltage pulse to be output from the modulation circuit A2. The modulation power source circuit A7 is generally a voltage source circuit, but it is not always limited to this.

The scanning circuit A3 is connected to scan wirings in the display panel A1. The scanning circuit A3 is designed to select one or more scan wirings to be driven from all of them (i.e., the N scan wirings), to then output a scan voltage pulse to the selected scan wirings. The scanning circuit A3 sequentially outputs the scan voltage pulses to the plurality of scan wirings by sequentially switching the scan wirings to which the scan voltage pulses are output. Although in general, the scan wirings are sequentially selected one by one in line sequential scanning, the plurality of scan wirings may be selected at the same time. Even when the plurality of scan wirings may be selected at the same time, all of the scan wirings cannot be selected at the same time. The scanning circuit A3 may perform interlaced scanning or select the plurality of wirings at the same time (multi-line scanning). The scanning circuit A3 supplies a selection potential (i.e., a scan voltage pulse) to the scan wiring to be driven (i.e., a selection line) whereas supplies a non-selection potential to the other scan wirings (i.e., non-selection line).

The scanning power source circuit A8 is a power source circuit for outputting the plurality of voltages (having the selection potential and the non-selection potential). The scanning power source circuit A8 is generally a voltage source circuit, but it is not always limited to this.

The control circuit A4 is configured to produce a timing signal serving as control data, based on which a timing of each of the modulation circuit A2, the scanning circuit A3, the data conversion circuit A5, and the parallel/serial conversion circuit A6 is controlled.

The data conversion circuit A5 is designed to convert luminance gradation data contained in the input video signal into image data suitable for the modulation circuit A2 and the display panel A1. The data conversion circuit A5 can subject the luminance gradation data to signal processing such as inverse γ conversion, luminance correction, color correction, resolution conversion, or maximum adjustment (limiter).

The parallel/serial conversion circuit A6 converts the parallel image data output from the data conversion circuit A5 into serial data, and then, outputs it to the modulation circuit A2.

Description will be made below on operation of the modulation circuit A2 in the present embodiment with reference to FIG. 2B.

A serial/parallel conversion circuit A9 converts the image data output from the parallel/serial conversion circuit A6 into parallel data. The image data converted into the parallel data is sequentially stored in a data sampling circuit A11 through a shift register A10.

The image data corresponding to the number of pixels in a horizontal direction of the display panel A1 (hereinafter, the number of pixels in the horizontal direction is set to M) is stored in the data sampling circuit A11. Thereafter, a logic circuit A12 produces a control signal (i.e., a control sequence) for an output circuit A13 based on the image data for each of the pixels stored in the data sampling circuit A11, and then, sends it to the output circuit A13.

The output circuit A13 produces a modulation voltage pulse in response to the control signal (i.e., the control sequence), thereby outputting the modulation voltage pulse to the modulation wiring in the display panel A1. The configuration of a unity gain buffer using an operation amplifier is suitable for the output circuit A13. Alternatively, an amplitude stage configuration for an operation amplifier may be used as the output circuit A13.

Subsequently, a description will be given below operation of the scanning circuit A3 in the present embodiment with reference to FIG. 2C. A shift register A14 is a logic circuit which determines one or more lines to be selected from the number of pixels in a vertical direction of the display panel A1 (hereinafter, the number of pixels in the vertical direction is set to N) in response to a control signal output from the timing generation circuit A4. The shift register A14 includes a shift register including a D flip-flop, not illustrated, and a logic device which performs logic calculation of the output of the shift register, a shift clock, and the output of shift data.

An output circuit A15 has the function of converting the shift data (i.e., a control signal) to be output from the shift register A14 into a voltage/current level required for driving the scan wirings, and then, outputting it.

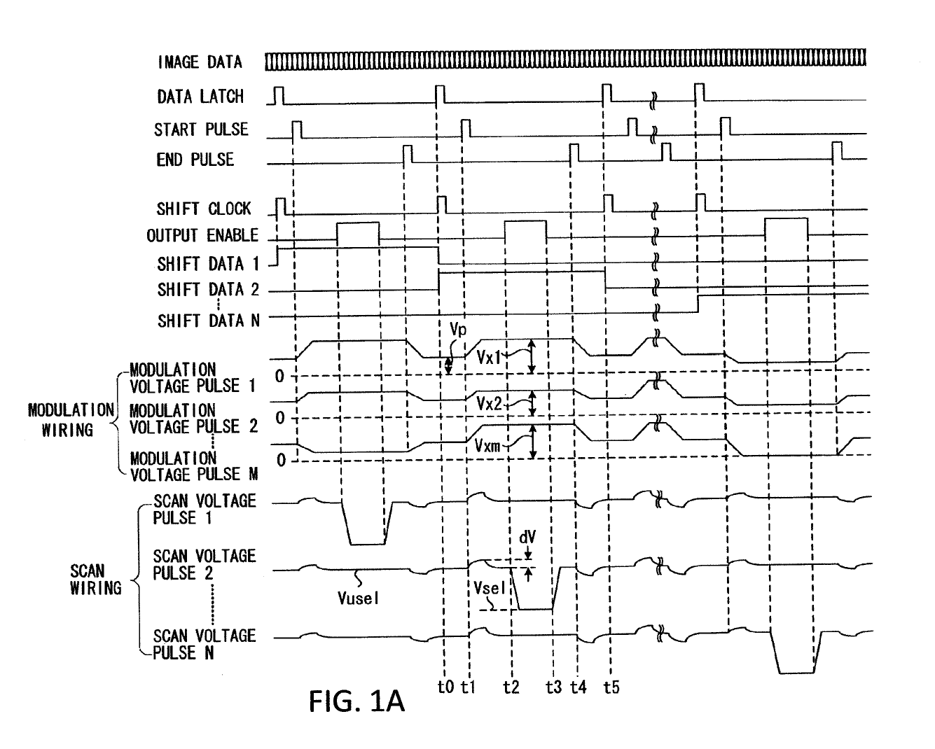

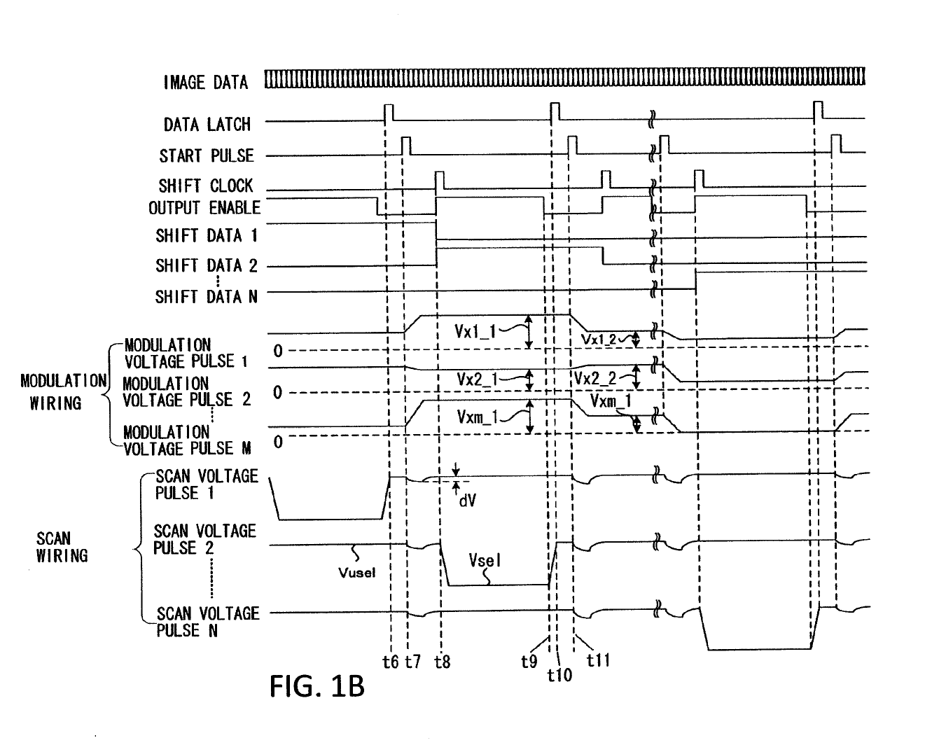

Hereinafter, a description will be given in detail of operation of the timing generation circuit A4 for controlling the modulation circuit A2 and the scanning circuit A3 in time series in the present embodiment with reference to a timing chart of FIG. 1A. Description will be made on operation between a timing t0 to a timing t5 (after selecting a second scan wiring from the top, a period of time required for driving a display device connected to the scan wiring (i.e., allowing the display device to emit the light)). In FIG. 1A, after selecting a topmost scan wiring, a period of time required for driving a display device connected to the scan wiring (i.e., allowing the display device to emit the light) is shown on a left side of the timing t0. In the same manner, after selecting a third scan wiring from the top, a period of time required for driving a display device connected to the scan wiring (i.e., allowing the display device to emit the light) is simply shown on a right side of the timing t5.

At the timing t0, image data corresponding to the number of pixels in a horizontal direction of the display panel A1 (corresponding to the number of modulation wirings) is stored in the data sampling circuit A11 by a data latch output from the control circuit A4.

At the same timing t0, when a shift clock is input into the scanning circuit A3, shift data in the shift register A14 inside of the scanning circuit A3 is shifted. In FIG. 1A, at the timing to, shift data 1 is transited from high to low whereas shift data 2 is transited from low to high, thereby shifting a selection line in sequence. Since output enable, described below, is low at this timing, a non-selection potential Vusel is applied to each of the scan wirings. Actually, no scan voltage pulse is regarded as being output to each of the scan wirings at this timing.

Next, at a timing t1, when a start pulse is input into the modulation circuit A2, the output circuit A13 starts outputting a modulation voltage pulse 1 to a modulation voltage pulse M to a modulation wiring in the display panel A1 according to the image data stored in the data sampling circuit A11. In particular, a potential (i.e., a peak value) to be applied to each of the modulation wirings is started to be transited from a certain potential Vp as a reference potential of a modulation voltage pulse to a predetermined potential Vx1 to Vxm according to the image data at a timing t1. A pulse waveform transited from the certain potential Vp serving as the reference potential of the modulation voltage pulse to the predetermined potential Vx1 to Vxm having a predetermined inclination and according to the image data is used as the waveform of the modulation voltage pulse in FIG. 1A. However, the waveform of the modulation voltage pulse is not limited to this, but any waveform of a modulation voltage pulse according to the characteristics of the electron emitting device on the display panel A1 may be used. Preferably, such a waveform should be moderately and monotonically increased (decreased) to reduce disturbance in waveform to the scan wiring. Up to a timing t4, described below, the potential (the peak value) to be applied to each of the modulation wirings is maintained to the predetermined potential Vx1 to Vxm according to the image data.

The reference potential Vp signifies a potential between a maximum potential and a minimum potential which can be output by the modulation circuit A2. The reference potential Vp is arbitrary as long as a difference from a potential (i.e., the non-selection potential Vusel) to be applied to the non-selection scan wiring is a threshold voltage or lower required for electron emission by the electron emitting device. In other words, the reference potential Vp is arbitrary as long as the difference from the potential (i.e., the non-selection potential Vusel) to be applied to the non-selection scan wiring is the threshold voltage or lower required for allowing (driving) the display device to emit the light. Preferably, the reference potential Vp should be set to a half of a difference between a maximum potential and a minimum potential which can be output by the modulation circuit A2 so as to reduce an average power consumption of a modulation signal. More preferably, the reference potential Vp should be set in such a manner as to be equal to the potential Vusel. In this manner, a voltage (the potential Vp minus the potential Vusel) to be applied to the display device which is not required to emit light (to be driven) becomes zero, so that a leakage current caused by the characteristics of the electron emitting device can become zero. Or, the potential Vp should be preferably set to a ground level so as to simplify the configuration of the circuit.

Subsequently, after the potential of a modulation voltage pulse 1 to a modulation voltage pulse M reaches a predetermined potential Vx1 to Vxm, an output enable signal is sent to the output circuit A15 at a timing t2. and then, a scan voltage pulse 2 is started to be output to a scan wiring (i.e., a second scan wiring) selected based on the shift data 2. In particular, the potential (i.e., the peak value) to be applied to the selected scan wiring (i.e., the second scan wiring) is started to be transited from the non-selection potential Vusel to the selection potential Vsel at a timing t2. In this manner, an image corresponding to one line is started to be displayed on the display panel A1. Until a timing t3, the potential (i.e., the peak value) to be applied to the scan wiring (i.e., the second scan wiring) is maintained at the selection potential Vsel. At a timing of a lapse of a predetermined period of time after the start of the output of the modulation voltage pulse, a scan voltage pulse 2 is started to be output. In other words, at a timing of a lapse of a predetermined period of time after the transition of the potential having the modulation voltage pulse 1 to the modulation voltage pulse M to the potential Vx1 to Vxm, the non-selection potential Vusel is started to be transited to the selection potential Vsel.

Next, at a timing t3, the output enable signal to be applied to the output circuit A15 is stopped, and then, the scan voltage pulse 2 is ended to be output to the scan wiring (i.e., the second scan wiring) selected based on the shift data 2. In particular, the potential (i.e., the peak value) to be applied to the selected scan wiring (i.e., the second scan wiring) is started to be transited from the selection potential Vsel to the non-selection potential Vusel at a timing t3. The scan voltage pulse 2 is ended to be output at a timing at which the potential of the selected scan wiring (i.e., the second scan wiring) is transited to the non-selection potential Vusel.

Thereafter, an end pulse is input into the modulation circuit A2 at a timing t4 after the scan voltage pulse 2 reaches the non-selection potential Vusel. Consequently, the output circuit A13 finishes outputting the modulation voltage pulse 1 to the modulation voltage pulse M to the modulation wiring in the display panel A1. In particular, a potential (a peak value) to be applied to each of the modulation wirings is started to be transited from a predetermined potential Vx1 to Vxm to a reference potential Vp. An output from a modulation voltage pulse 1 to a modulation voltage pulse M is ended at a timing at which the potential at each of the modulation wirings is transited to the reference potential Vp.

Therefore, the width of the modulation voltage pulse is controlled to be longer than that of the scan voltage pulse. The output of the modulation voltage pulse comes to an end at the timing of the lapse of the predetermined period of time after the end of the output of the scan voltage pulse 2. In other words, at the timing of the lapse of the predetermined period of time after the transition from the selection potential Vsel to the non-selection potential Vusel, the transition is started from the potential Vx1 to Vxm of the modulation voltage pulse 1 to the modulation voltage pulse M to the reference potential Vp.

The above-described operation is repeated with respect to the different scan wirings in sequence, thereby displaying the image corresponding to one screen.

In the present embodiment, a disturbance dV in waveform (i.e., a crosstalk) can be caused during a period other than that during which the scan voltage pulse is applied, thereby suppressing the deterioration of gradation controllability, as is clear from the waveform of the scan voltage pulse illustrated in FIG. 1A.

### Second Embodiment

Description will be made below on a second embodiment.

In the first embodiment, the potential of the modulation voltage pulse is started to be transited toward the potential Vp irrespective of the potential of the modulation voltage pulse to be output to the modulation wiring during a next selection period of time at the timing t4. In contrast, the present embodiment is different from the first embodiment in that the potential is transited toward the potential (the amplitude) of the modulation voltage pulse to be output to the modulation wiring during a next selection period of time. The other matters are the same as those in the first embodiment, and therefore, their detailed description will not be repeated.

A description will be given in detail of operation of the timing generation circuit A4 for controlling the modulation circuit A2 and the scanning circuit A3 in time series in the present embodiment with reference to a timing chart of FIG. 1B. Description will be made on operation between a timing t6 to a timing t11 (after selecting a second scan wiring from the top, a period of time required for driving a display device connected to the scan wiring, i.e., allowing the display device to emit light). In FIG. 1B, after selecting a topmost scan wiring, a period of time required for driving a display device connected to the scan wiring (allowing the display device to emit light) is shown on a left side of the timing t6. In the same manner, after selecting a third scan wiring from the top, a period of time required for driving a display device connected to the scan wiring (allowing the display device to emit the light) is simply shown on a right side of the timing t11.

First of all, at the timing t6, image data corresponding to the number of pixels in a horizontal direction of the display panel A1 (corresponding to the number of modulation wirings) is stored in the data sampling circuit A11 by a data latch output from the control circuit A4.

Next, in a timing t7, when a start pulse is input into the modulation circuit A2, the output circuit A13 starts outputting a modulation voltage pulse 1 to a modulation voltage pulse M to a modulation wiring according to the image data stored in the data sampling circuit A11. A waveform transited to a predetermined potential Vx1_1 to Vxm_1 having a predetermined inclination and according to the image data is used as the waveform of the modulation voltage pulse in FIG. 1B. However, the waveform of the modulation voltage pulse is not limited to this, but any waveform of a modulation voltage pulse according to the characteristics of the electron emitting device in the display panel A1 may be used. Such a waveform should be preferred that is moderately and monotonically increased (decreased) to reduce disturbance in waveform to the scan wiring. Up to a timing t11, described below, the potential (the peak value) to be applied to each of the modulation wirings is maintained to the predetermined potential Vx1_1 to Vxm_1 according to the image data.

Next, at a timing t8 after the modulation voltage pulse 1 to the modulation voltage pulse M reaches the predetermined potentials Vx1_1 to Vxm_1, when a shift clock is input into the scanning circuit A3, shift data in the shift register A14 inside of the scanning circuit A3 is shifted. In FIG. 1B, at the timing t8, shift data 1 is transited from high to low whereas shift data 2 is transited from low to high, thereby shifting a selection line in sequence. Moreover, an output enable signal is sent to the output circuit A15, and then, a scan voltage pulse 2 is started to be output to a scan wiring (i.e., a second scan wiring from the top) selected based on the shift data 2. In particular, the potential (i.e., the peak value) to be applied to the selected scan wiring (i.e., the second scan wiring from the top) is started to be transited from the non-selection potential Vusel to the selection potential Vsel at a timing t8. In this manner, an image corresponding to one line is started to be displayed on the display panel A1. Until a timing t9, the potential (i.e., the peak value) to be applied to the scan wiring (i.e., the second scan wiring from the top) is maintained at the selection potential Vsel.

Next, at a timing t9, the output enable signal to be sent to the output circuit A15 is stopped, and then, the scan voltage pulse 2 is ended to be output to the scan wiring (i.e., the second scan wiring from the top) selected based on the shift data 2. In particular, the potential (i.e., the peak value) to be applied to the selected scan wiring (i.e., the second scan wiring from the top) is started to be transited from the selection potential Vsel to the non-selection potential Vusel at the timing t9. The scan voltage pulse 2 is ended to be output at a timing at which the potential of the selected scan wiring (i.e., the second scan wiring from the top) is transited to the non-selection potential Vusel.

Next, at a timing t10 after the scan voltage pulse 2 reaches the non-selection potential Vusel, image data according to the number of pixels in the horizontal direction of the display panel A1 (according to the number of modulation wirings) is stored in the data sampling circuit A11 by the data latch in the same manner as at the timing t6. The stored image data corresponds to image data corresponding to a display device connected to the scan wiring selected based on shift data 3 (a third scan wiring from the top).

Next, at a timing t11, when a start pulse is input into the modulation circuit A2, the output circuit A13 starts outputting a modulation voltage pulse 1 to a modulation voltage pulse M to a modulation wiring according to the image data stored in the data sampling circuit A11. In particular, transition from predetermined potentials Vx1_1 to Vxm_1 according to image data, of the potential (i.e., the peak value) to be applied to each of the modulation wirings to predetermined potentials Vx1_2 to Vxm_2 is started. As a consequence, a timing of completion of the transition from potentials Vx1_1 to Vxm_1 to the potentials Vx1_2 to Vxm_2 may be regarded as a completion timing of the output of the modulation voltage pulse 1 to the modulation voltage pulse M having the potentials Vx1_1 to Vxm_1 as the peak values according to the image data.

Therefore, the width of the modulation voltage pulse is controlled to be longer than that of the scan voltage pulse.

The above-described operation is repeated with respect to the different scan wirings in sequence, thereby displaying the image corresponding to one screen.

In the second embodiment, the potential (the peak value) of the modulation voltage pulse is controlled to be transited to the potential of the modulation voltage pulse to be applied during the following selection period of time at the timing t11. As a consequence, the number of times of electrically charging/discharging a wiring capacitance generated in the modulation wiring or the scan wiring or the device capacitance of the electron emitting device in the display panel A1 can be reduced, thereby saving power consumption. For example, in the case where the image data according to the modulation voltage pulse to be sequentially output to the same modulation wiring is constant (i.e., not varied), the potential (the peak value) of the modulation voltage pulse to be output is also constant (i.e., not varied). Hence, in the second embodiment, the modulation voltage pulse may have the same potential irrespective of the selection period or the non-selection period, and therefore, it is unnecessary to electrically charging/discharging the capacitance. Consequently, the power consumed by the electric charging/discharging (i.e., the capacitance×the output potential×the output potential×the frequency) can become zero.

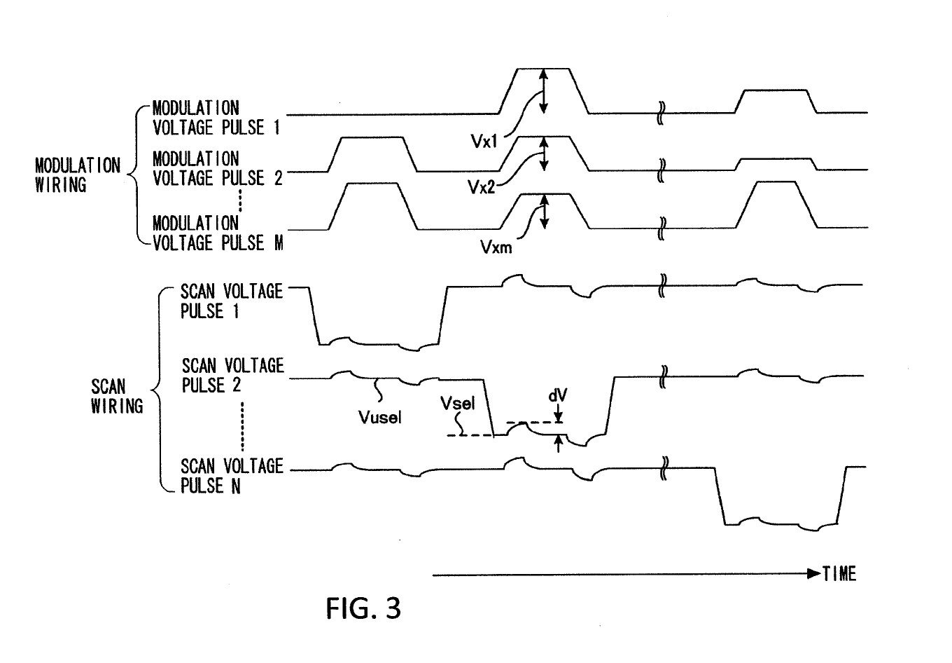

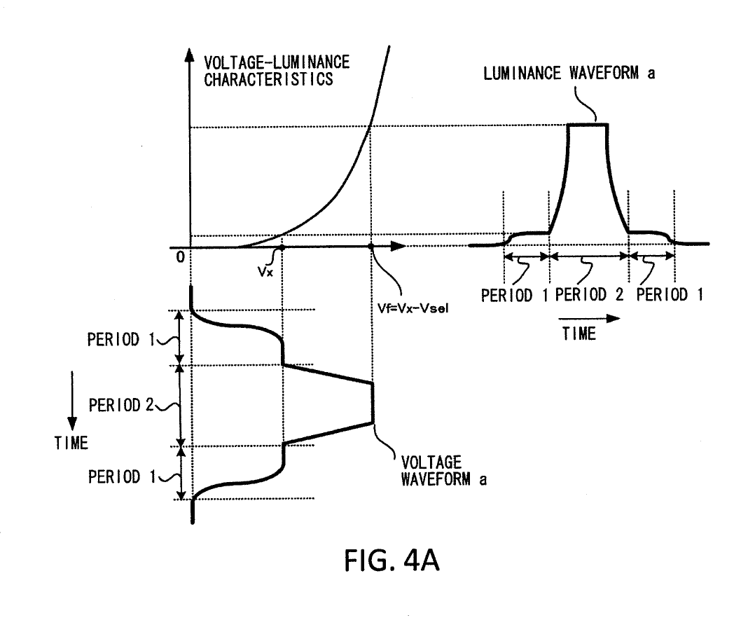

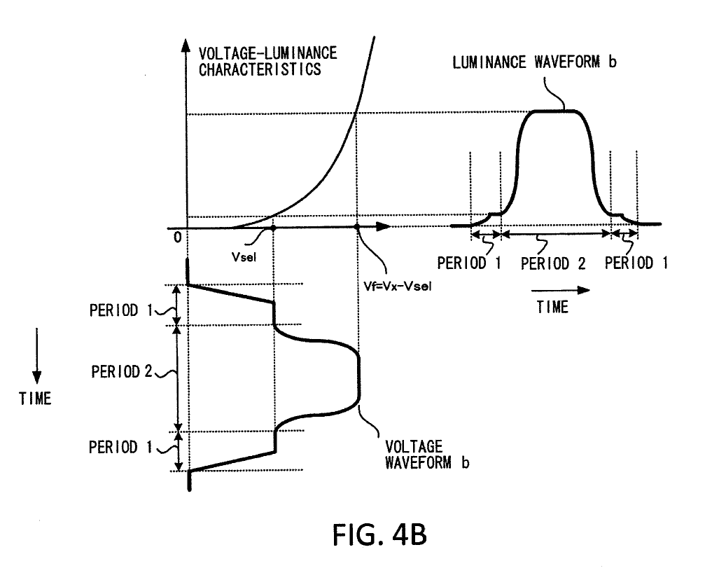

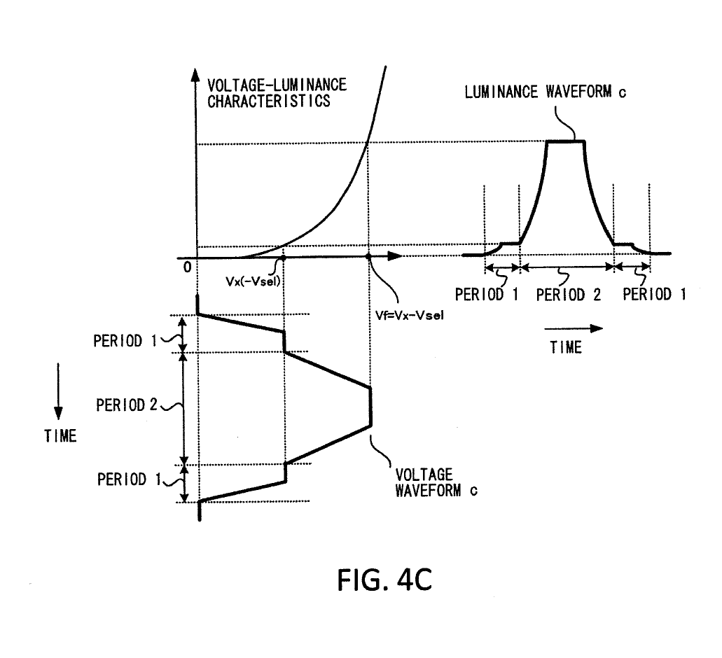

Effects obtained by the above-described embodiment will be described in detail below. FIGS. 4A to 4C illustrate voltage-luminance characteristics of a certain pixel (i.e., a display device) in the display panel A1 and luminance waveforms displayed when voltage waveforms a to c illustrated in the graphs are applied to the display device. FIG. 4A illustrates the voltage-luminance characteristics in the above-described embodiment; FIG. 4B illustrates the voltage-luminance characteristics when the pulse waveform having the relationship illustrated in FIG. 3 is applied; and FIG. 4C illustrates the voltage-luminance characteristics in a theoretical state.

The luminance waveform of the pixel (the display device) in the theoretical state is represented by c in FIG. 4C. However, the pulse waveform having the relationship illustrated in FIG. 3 or the pulse waveform having the relationship illustrated in FIG. 1A or 1B in the above-described embodiment is applied, the wiring capacitance generated in the modulation wiring or the scan wiring or the device capacitance of the electron emitting device causes a disturbance in potential of the scan wiring. In other words, a distorted voltage waveform is unintentionally obtained with respect to the voltage waveform c in the theoretical state. As a result, the luminance waveform also is distorted, thereby inducing degradation of a quality of an image.

When the pulse waveform having the relationship illustrated in FIG. 3 is applied (FIG. 4B), the peak value of the modulation voltage pulse is transited to the predetermined potential Vx after the peak value of the scan voltage pulse is transited to the selection potential Vsel, and therefore, the voltage waveform b is distorted during a period 2.

On the other hand, the waveform is similarly distorted also in the case of the above-described embodiment (FIG. 4A). However, this case is different from that in FIG. 4B in that the peak value of the scan voltage pulse is controlled to be transited to the selection potential Vsel after the peak value of the modulation voltage pulse is transited to the predetermined potential Vx. Therefore, the voltage waveform a is distorted during a period 1. In the case disclosed in Japanese Patent Application Laid-open No. 2007-108365, the distortion of the voltage waveform occurs during the period 1 at the beginning of the driving but occurs during the period 2 at the end of the driving.

Noting a change ratio of luminance with respect to a change in voltage in the voltage-luminance characteristics (hereinafter referred to as a luminance inclination) during the period 1 illustrated in FIG. 4A and the period 2 illustrated in FIG. 4B, the luminance inclination during the period 1 is more moderate than that during the period 2. Specifically, the luminance change if the voltage waveform a is distorted during the period 1 less influences the luminance than the luminance change if the voltage waveform b is distorted during the period 2, and therefore, the waveform more approaches that illustrated in FIG. 4C showing the theoretical state.

Namely, in the above-described embodiment, the distortion occurs during a period in which the luminance inclination is small, thereby remarkably alleviating the influence on the image.

Thus, an electron emitting device of an electric field emission type such as an FE type electron emitting device, an MIM type electron emitting device, or a surface conduction type electron emitting device in which a ratio of the luminance inclination during the period 2 with respect to the luminance inclination during the period 1 is as great as about 1,000 to about 1,000,000 is suitable for the electron emitting device for use in the electron beam display apparatus. Although the voltage driving is exemplified in the above-described embodiment, it is not limited to this. It is to be understood that current driving or electric charge driving may be applicable.

Regarding how long the timings t1 and t2 and the timings t4 and t5 in FIG. 1A and the timings t7 and t8 in FIG. 1B are set, a timing at which the crosstalk potential dV of the waveform distortion becomes zero is preferred. However, it is not limited to this in consideration of the characteristics (the luminance inclination) of the electron emitting device, and therefore, any timing at which dV≈0 is sufficient as long as no influence is exerted on the quality of an image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-145455, filed on Jun. 18, 2009, which is hereby incorporated by reference herein its entirety.

What is claimed is:

1. A method for controlling an image display apparatus provided with a display panel including a plurality of scan wirings, a plurality of modulation wirings, a plurality of electron emitting devices, each of which is connected to any one of the plurality of scan wirings and any one of the plurality of modulation wirings, and a plurality of light emitting members for emitting light by irradiation with an electron emitted from the electron emitting device, the method comprising the steps of:
outputting a scan voltage pulse to a scan wiring selected from the plurality of scan wirings; and
generating a modulation voltage pulse based on image data, and outputting the modulation voltage pulse to the plurality of modulation wirings,
wherein a set of the electron emitting devices for emitting electrons is switched in a line-sequential manner by switching of the scan wiring being supplied with the scan voltage pulse,
the modulation voltage pulse being generated such that its pulse width becomes longer than a width of the scan voltage pulse, and
the modulation voltage pulse being started to be output before the start of the output of the scan voltage pulse whereas it being ended after the end of the output of the scan voltage pulse.

2. An image display apparatus comprising:
a display panel including a plurality of scan wirings, a plurality of modulation wirings, a plurality of electron emitting devices, each of which is connected to any one of the plurality of scan wirings and any one of the plurality of modulation wirings, and a plurality of light emitting members for emitting light by irradiation with an electron emitted from the electron emitting device;
a scanning unit which sequentially outputs a scan voltage pulse to the plurality of scan wirings;
a modulation unit which outputs a modulation voltage pulse generated based on image data to the plurality of modulation wirings; and
a control unit which controls the scanning unit and the modulation unit,
wherein the scanning unit switches a set of electron emitting devices for emitting electrons in a line-sequential manner by switching of the scan wiring being supplied with the scan voltage pulse,
the modulation unit generates a pulse having a longer width than that of the scan voltage pulse as the modulation voltage pulse, and
the control unit controls the scanning unit and the modulation unit in such a manner as to start to output the modulation voltage pulse before the start of the output of the scan voltage pulse whereas to end outputting the modulation voltage pulse after the end of the output of the scan voltage pulse.

3. A method for controlling an image display apparatus provided with a display panel including a plurality of light emitting members for emitting light by irradiation with electrons emitted from a plurality of electron emitting devices arranged in a matrix with a plurality of scan wirings and a plurality of modulation wirings, a scanning unit which outputs a selection potential to a scan wiring selected from the plurality of scan wirings and outputting a non-selection potential to non-selected scan wirings, and a modulation unit which generates a modulation voltage pulse based on image data and outputs the modulation voltage pulse to the modulation wirings, a set of the electron emitting devices for emitting electrons being switched in a line-sequential manner by switching of the scan wiring being supplied with the selection potential, the method comprising the steps of:
transiting a potential output to the scan wiring selected from the plurality of scan wirings from the scanning unit from the non-selection potential to the selection potential, at a timing after a lapse of a predetermined period of time after a potential of the modulation voltage pulse to be output to the modulation wiring from the modulation unit is transited to a potential based on the image data; and
transiting the potential of the modulation voltage pulse to be output to the modulation wiring from the modulation unit to a potential Vp having a difference from the non-selection potential, the difference being equal to or lower than a threshold voltage required for light emission in the electron emitting device, at a timing after a lapse of a predetermined period of time after the potential to be output from the scanning unit to the selected scan wiring is transited from the selection potential to the non-selection potential.

4. A method for controlling an image display apparatus according to claim 3, wherein the amplitude of the modulation voltage pulse is modulated.

5. A method for controlling an image display apparatus according to claim 3, wherein the potential Vp is a ground level.

6. A method for controlling an image display apparatus according to claim 3, wherein the potential Vp is a half of a difference between a maximum potential and a minimum potential which can be output from the modulation unit.

7. A method for controlling an image display apparatus according to claim 3, wherein the potential Vp is equal to the non-selection potential.

8. A method for controlling an image display apparatus according to claim 3, wherein the potential Vp is equal to a potential of a modulation voltage pulse based on image data corresponding to a electron emitting device connected to a scan wiring selected next by the scanning unit.

9. An image display apparatus comprising:
a display panel including a plurality of light emitting members for emitting light by irradiation with electrons emitted from a plurality of electron emitting devices arranged in a matrix with a plurality of scan wirings and a plurality of modulation wirings,
a scanning unit which outputs a selection potential to a scan wiring selected from the plurality of scan wirings and outputs a non-selection potential to non-selected scan wirings,
a modulation unit which generates a modulation voltage pulse based on image data and outputs the modulation voltage pulse to the modulation wirings, and
a control unit which generates a control signal to control the scanning unit and the modulation unit,
wherein
a set of the electron emitting devices for emitting electrons is switched in a line-sequential manner by switching of the scan wiring being supplied with the selection potential,
the control unit controls the scanning unit and the modulation unit such that a potential output to the scan wiring selected from the plurality of scan wirings from the scanning unit is transited from the non-selection potential to the selection potential, at a timing after a lapse of a predetermined period of time after a potential of the modulation voltage pulse to be output to the modulation wiring from the modulation unit is transited to a potential based on the image data, and
the control unit controls the scanning unit and the modulation unit such that the potential of the modulation voltage pulse to be output to the modulation wiring from the modulation unit is transited to a potential Vp having a difference from the non-selection potential, the difference being equal to or lower than a threshold voltage required for light emission in the electron emitting device, at a timing after a lapse of a predetermined period of time after the potential to be output from the scanning unit to the selected scan wiring is transited from the selection potential to the non-selection potential.
